(19) United States
(12) Patent Application Publication
(10) Pub. No.: US 2019/0375446 A1
(43) Pub. Date: Dec. 12, 2019

(54) SYSTEMS AND METHODS FOR STEERING WHEEL ALIGNMENT AND MOTION CONTROL

(71) Applicant: GM GLOBAL TECHNOLOGY OPERATIONS LLC, Detroit, MI (US)

(72) Inventors: John T. Zuzelski, Clarkston, MI (US); Scott R. Kloess, Rochester Hills, MI (US); Eric B. Hoyer, White Lake, MI (US)

(21) Appl. No.: 16/002,038

(22) Filed: Jun. 7, 2018

(51) Int. Cl. B62D 5/00; B62D 5/04

(52) U.S. Cl. CPC B62D 5/006; B62D 6/008; B62D 5/046

(57) ABSTRACT

An exemplary method for controlling a vehicle includes the steps of providing a vehicle steering system including a steering wheel, providing a control system in electronic communication with the vehicle steering system, the control system including a controller, determining a rotational position change, generating a control signal indicating the rotational position change, and adjusting a position of the steering wheel from a first position to a second position based on the control signal.

### INTRODUCTION

The present invention relates generally to the field of vehicles and, more specifically, to a steer-by-wire system for a vehicle that allows the operator to specify a desired steering wheel alignment and motion.

A steer-by-wire system allows the vehicle to be steered electronically, i.e., without a direct mechanical link between the steering wheel and the vehicle wheels. Steer-by-wire systems allow vehicle interior design freedoms that might otherwise not be possible with a conventional steering system having a mechanical linkage. Further, steer-by-wire systems typically have fewer parts and reduced complexity than conventional steering systems.

Many factors can lead to vehicle steering wheel and road wheel misalignment. Additionally, operator seating position has an effect on perceived steering wheel alignment. Real or perceived steering wheel and road wheel misalignment can lead to customer dissatisfaction as well as increased vehicle warranty expense.

### SUMMARY

Embodiments according to the present disclosure provide a number of advantages. For example, embodiments according to the present disclosure enable incremental and selectable control of a desired steering wheel rotational position and motion.

In one aspect, a system for controlling a vehicle includes a vehicle steering system including a steering wheel, a steering column, a motor coupled to the steering column, and a position sensor, a control system in electronic communication with the vehicle steering system, the control system including a controller, and an input device in electronic communication with the controller of the control system. The controller is configured to receive input data from the input device, convert the input data into a rotational position change, generate a control signal indicating the rotational position change, and adjust a position of the steering wheel from a first position to a second position based on the control signal.

In some aspects, the input device is a touchscreen.

In some aspects, the vehicle steering system is a steer-by-wire steering system.

In some aspects, the rotational position change represents an operator steering wheel position preference.

In some aspects, adjusting the position of the steering wheel from the first position to the second position includes rotating the steering wheel based on the rotational position change.

In some aspects, wherein the controller is further configured to adjust a steering wheel rotation setting to one or more of a non-rotation setting, a partial rotation setting, and a full rotation setting.

In some aspects, the controller is further configured to receive position data from the position sensor, the position data indicative of the first position of the steering wheel.

In another aspect, a method for controlling a vehicle includes the steps of providing a vehicle steering system including a steering wheel, providing a control system in electronic communication with the vehicle steering system, the control system including a controller, determining, by the controller, a rotational position change, generating, by the controller, a control signal indicating the rotational position change, and adjusting, by the steering system, a position of the steering wheel from a first position to a second position based on the control signal.

In some aspects, the vehicle steering system is a steer-by-wire steering system.

In some aspects, the method further includes providing an input device in electronic communication with the control system, receiving, by the controller, input data from the input device, and converting, by the controller, the input data into the rotational position change.

In some aspects, the input device is a touchscreen.

In some aspects, the input data indicates a steering wheel rotation setting.

In some aspects, determining the rotational position change includes determining an average steering wheel rotational position.

In some aspects, the method further includes adjusting, by the steering system, an amount of rotation of the steering wheel from a first steering wheel rotation setting to a second steering wheel rotation setting.

In yet another aspect, an automotive vehicle includes a body, a steering system coupled to the body, the steering system including a steering wheel, a steering column, a motor coupled to the steering column, and a position sensor, an input device, and a controller in electronic communication with the motor, the position sensor, and the input device. The controller is configured to receive input data from the input device, convert the input data into a rotational position change, generate a control signal indicating the rotational position change, and adjust a position of the steering wheel from a first position to a second position.

In some aspects, the input device is a touchscreen and the vehicle steering system is a steer-by-wire steering system.

In some aspects, the rotational position change represents an operator steering wheel position preference.

In some aspects, adjusting the position of the steering wheel from the first position to the second position includes rotating the steering wheel based on the rotational position change.

In some aspects, the controller is further configured to adjust a steering wheel rotation setting to one or more of a non-rotation setting, a partial rotation setting, and a full rotation setting.

In some aspects, the controller is further configured to receive position data from the position sensor, the position data indicative of the first position of the steering wheel.

### BRIEF DESCRIPTION OF THE DRAWINGS

The present disclosure will be described in conjunction with the following figures, wherein like numerals denote like elements.

FIG. 1 is a functional block diagram of a vehicle that includes, among other features, a steering system in accordance with exemplary embodiments.

FIG. 2 is a functional block diagram of a control system for a vehicle steering system, according to an embodiment.

FIG. 3 is a flowchart of a method for controlling a vehicle, specifically a steering wheel position, according to an embodiment.

The foregoing and other features of the present disclosure will become more fully apparent from the foil owing description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words sped ti cal y mentioned above, derivatives thereof, and words of similar import.

In the execution of steer-by-wire technology, the intermediate shaft is removed between the steering column and the steering gear. This allows the steering column and steering wheel, in some embodiments, to rotate without travel limits or to rotate within predefined and/or adjustable limits. The technologies of steer-by-wire and active front steering allow the steering wheel position and the front road wheels to be independent of each other; that is, the steering wheel position may not be indicative of the front road wheel angle. Embodiments discussed herein enable the operator to adjust the steering wheel position to a desired position based on operator preference, among other factors. In some embodiments, an operator input device, such as a screen, for example, an operator's information center screen, provides a means for receiving operator input regarding a desired steering wheel position angle. Allowing the operator to adjust the steering wheel rotation angle or center position can improve operator satisfaction. The terms “steering wheel position” and “steering wheel center position” refer to a steering wheel angle position that is incrementally adjustable both clockwise and counterclockwise as discussed herein.

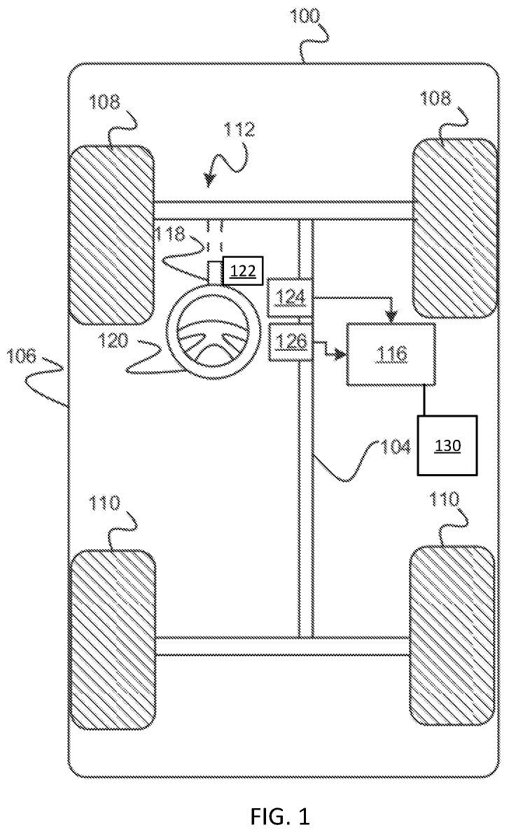

With reference to FIG. 1, a vehicle 100 is shown that includes a steering system 112 in accordance with various embodiments. Although the figures shown herein depict an example with certain arrangements of elements, additional intervening elements, devices, features, or components may be present in an actual embodiment. It should also be understood that FIG. 1 is merely illustrative and may not be drawn to scale.

As depicted in FIG. 1, the vehicle 100 generally includes a chassis 104, a body 106, front wheels 108, rear wheels 110, a steering system 112, and a control system 116. The body 106 is arranged on the chassis 104 and substantially encloses the other components of the vehicle 100. The body 106 and the chassis 104 may jointly form a frame. The wheels 108-110 are each rotationally coupled to the chassis 104 near a respective corner of the body 106.

As can be appreciated, the vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD). The vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and ethanol), a gaseous compound (e.g., hydrogen or natural gas) fueled engine, a combustion/electric motor hybrid engine, and an electric motor.

In some embodiments, the steering system 112 includes a steering column assembly 118 and a steering wheel 120. In various embodiments, the steering system 112 is a steer-by-wire system in which the steering column assembly 118 and the steering wheel 120 are electronically connected to a steering rack (not shown). In various embodiments, the steering system 112 makes use of electric motors to turn the wheels, sensors to determine how much steering force to apply, and steering feel emulators to provide haptic feedback to the driver.

In various embodiments, the steering system 112 includes a motor 122 that is coupled to the steering system 112. The motor 122 can be coupled to the rotatable shaft of the steering column assembly 118. The steering system 112 further includes one or more sensors that sense observable conditions of the steering system 112. In various embodiments, the steering system 112 includes a torque sensor 124 and a position sensor 126. The torque sensor 124 senses a rotational torque applied to the steering system by for example, a driver of the vehicle 100 via the steering wheel 120 and generates torque signals based thereon. The position sensor 126 senses a rotational position of the steering wheel 120 and generates position signals based thereon.

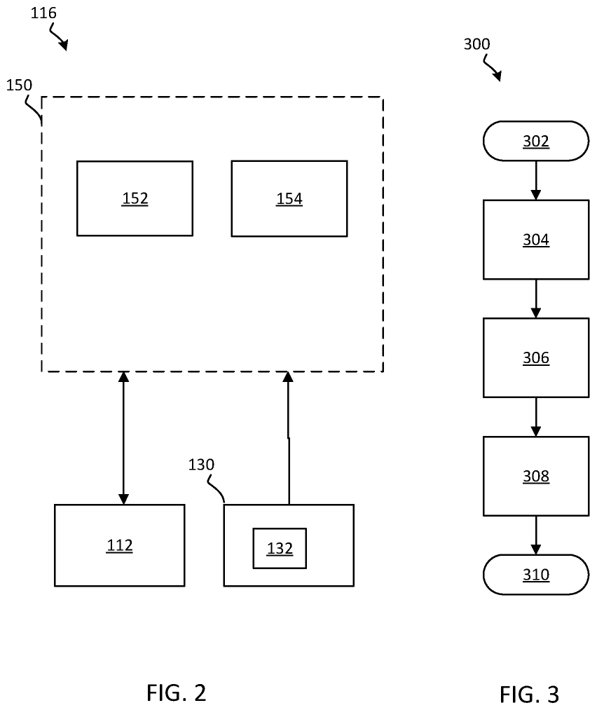

As shown in FIG. 2, in some embodiments, the control system 116 includes a controller 150. The controller 150 includes at least one processor 152 and a computer readable storage device or media 154. The processor 152 can be any custom made or commercially available processor, a central processing unit (CPU), a graphics processing unit (GPU), an auxiliary processor among several processors associated with the controller, a semiconductor based microprocessor (in the form of a microchip or chip set), a macroprocessor, any combination thereof, or generally any device for executing instructions. The computer readable storage device or media 154 may include volatile and nonvolatile storage in read-only memory (ROM), random-access memory (RAM), and keep-alive memory (KAM), for example. KAM is a persistent or non-volatile memory that may be used to store various operating variables while the processor 152 is powered down. The computer-readable storage device or media 154 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 150 in controlling the vehicle 100.

The control system 116 receives the sensor signals and monitors operation of the steering system 112 based thereon. In general, the control system 116 receives the sensor signals, such as, for example and without limitation, torque sensor signals, steering wheel angle signals, and other signals, and processes the sensor signals over a certain time period to determine the torque to apply to the wheels.

In some embodiments, the vehicle 100 also includes at least one operator input system 130. The operator input system 130 includes, in some embodiments, one or more operator input devices 132, such as knobs, buttons, a touchscreen, etc. that can accept operator input regarding a desired steering wheel position. In some embodiments, the operator input is a desired clockwise or counterclockwise steering wheel position change. In some embodiments, the operator input device 132 may be located on or near the steering wheel 120, incorporated into an operator information center in the vehicle dashboard, etc. In some embodiments, the operator input system 130 can both visually (via, for example, a display) and/or audibly (via, for example, speakers) provide feedback to the operator regarding a current and/or desired steering wheel position. In some embodiments, the operator input system 130 is in electronic communication with the control system 116.

FIG. 3 illustrates a method 300 to control a vehicle steering system, including a steering wheel position and/or rotation, according to an embodiment. The method 300 can be utilized in connection with the control system 116, the steering system 112, and the operator input system 130 of the vehicle 100. The method 300 can be utilized in connection with the controller of the control system 116 as discussed herein, or by other systems associated with or separate from the vehicle, in accordance with exemplary embodiments. The order of operation of the method 300 is not limited to the sequential execution as illustrated in FIG. 3, but may be performed in one or more varying orders, or steps may be performed simultaneously, as applicable in accordance with the present disclosure. In some embodiments, the method 300 is used to perform an automatic adjustment of a steering wheel center position by the control system 116 and/or the steering system 112 based on operator input. In some embodiments, the method 300 is used to perform an adjustment of the steering wheel center position by the control system 116 and/or the steering system 112 based on a long-term average steering wheel center position that can be used to automatically adjust the center or “zero” point of the steering wheel center position without operator input.

The method 300 begins at 302 and proceeds to 304. At 304, the controller 150 of the control system 116 receives a signal from the operator input device 132. In some embodiments, the signal includes an instruction to adjust a rotational position of the steering wheel 120. In some embodiments, the signal includes a steering wheel rotation setting instruction.

In some embodiments, the operator provides an instruction, via the operator input device 132, to adjust the rotational position of the steering wheel 120 in either a clockwise or counterclockwise direction. In some embodiments, the instruction includes an incremental rotational position change, wherein the increments are approximately 0.5 degree increments, approximately 1 degree increments, approximately 1.5 degree increments, etc. In some embodiments, a maximum rotational change limit is approximately 10 degrees, that is, the steering wheel rotational position may be changed up to and including 10 degrees either clockwise or counterclockwise. In other embodiments, a maximum rotational change limit is greater than or less than approximately 10 degrees either clockwise or counterclockwise.

Some vehicle passengers may prefer the cue of a rotating steering wheel when the vehicle is operating in an autonomous or semi-autonomous mode. The orientation of the steering wheel and whether the steering wheel rotates with the vehicle operation may be customizable based on the passenger's preference. For example, the operator or passenger of the autonomous or semi-autonomous vehicle may be able specify a preferred steering wheel rotation setting such as partial rotation, full rotation, or non-rotation using the operator input device 132.

The method 300 then proceeds to 304. At 304, the controller 152 of the control system 116 analyzes the operator input data. In some embodiments, the controller 152 converts the signal received from the operator input device 132 into a desired rotational position change in degrees. In some embodiments, for example and without limitation, the conversion includes converting an operator's left or right swipe on a touchscreen, an input received from one or more buttons, or a rotation of a knob in a clockwise or counterclockwise direction into the desired steering wheel rotational position change from a current steering wheel position.

Next, at 306, the controller 152 generates a control signal to adjust the steering wheel position from a first position (that is, the current steering wheel position) to a second position (that is, the desired steering wheel rotational position). In some embodiments, the control signal is transmitted to a motor, such as the motor 122, or a motor/emulator of the steering system 116.

In some embodiments, the control signal is indicative of the steering wheel rotation setting. The steering wheel rotation setting is one of a non-rotation setting, a partial rotation setting, and a full rotation setting. In some embodiments, the steering wheel rotation setting is a desired setting received from the operator or a passenger of the vehicle 100 via the operator input device 132.

At 308, the motor 122 or the motor/emulator of the steering system 116 receives the control signal and adjusts the position of the steering wheel from the first position to the second position. In some embodiments, adjusting the position of the steering wheel from the first position to the second position includes rotating the steering wheel based on the rotational position change. IN some embodiments, the motor 122 or the motor/emulator of the steering system 116 receives the steering wheel rotation setting and adjust the amount of rotation of the steering wheel accordingly, that is, allowing partial or full rotation or holding the steering wheel in a non-rotation position. The method 300 then proceeds to 310 and ends.

In some embodiments, the rotational position of the steering wheel 120 is automatically adjusted based on a long-term average setting of the steering wheel center position without receipt of operator input. In some embodiments, the controller 150 analyzes data obtained from previous steering wheel center position adjustments to determine an average setting of the steering wheel center position and automatically adjusts the steering wheel to the calculated average position.

The methods and systems discussed herein may be used with vehicles having steer-by-wire steering systems. Additionally, the methods and systems discussed herein may be used with autonomous or semi-autonomous vehicles.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features; elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1” and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A system for controlling a vehicle, comprising:
a vehicle steering system including a steering wheel, a steering column, a motor coupled to the steering column, and a position sensor;
a control system in electronic communication with the vehicle steering system, the control system including a controller; and
an input device in electronic communication with the controller of the control system;
wherein the controller is configured to
receive input data from the input device;
convert the input data into a rotational position change;
generate a control signal indicating the rotational position change; and
adjust a position of the steering wheel from a first position to a second position based on the control signal.

2. The system of claim 1, wherein the input device is a touchscreen.

3. The system of claim 1, wherein the vehicle steering system is a steer-by-wire steering system.

4. The system of claim 1, wherein the rotational position change represents an operator steering wheel position preference.

5. The system of claim 1, wherein adjusting the position of the steering wheel from the first position to the second position comprises rotating the steering wheel based on the rotational position change.

6. The system of claim 1, wherein the controller is further configured to adjust a steering wheel rotation setting to one or more of a non-rotation setting, a partial rotation setting, and a full rotation setting.

7. The system of claim 1, wherein the controller is further configured to receive position data from the position sensor, the position data indicative of the first position of the steering wheel.

8. A method for controlling a vehicle, comprising:
providing a vehicle steering system including a steering wheel;
providing a control system in electronic communication with the vehicle steering system, the control system including a controller;
determining, by the controller, a rotational position change;
generating, by the controller, a control signal indicating the rotational position change; and
adjusting, by the steering system, a position of the steering wheel from a first position to a second position based on the control signal.

9. The method of claim 8, wherein the vehicle steering system is a steer-by-wire steering system.

10. The method of claim 8, further comprising providing an input device in electronic communication with the control system, receiving, by the controller, input data from the input device, and converting, by the controller, the input data into the rotational position change.

11. The method of claim 10, wherein the input device is a touchscreen.

12. The method of claim 10, wherein the input data indicates a steering wheel rotation setting.

13. The method of claim 8, wherein determining the rotational position change comprises determining an average steering wheel rotational position.

14. The method of claim 8, further comprising adjusting, by the steering system, an amount of rotation of the steering wheel from a first steering wheel rotation setting to a second steering wheel rotation setting.

15. An automotive vehicle, comprising:
a body;
a steering system coupled to the body, the steering system including a steering wheel, a steering column, a motor coupled to the steering column, and a position sensor;
an input device; and
a controller in electronic communication with the motor, the position sensor, and the input device;
wherein the controller is configured to
receive input data from the input device;
convert the input data into a rotational position change;
generate a control signal indicating the rotational position change; and
adjust a position of the steering wheel from a first position to a second position.

16. The automotive vehicle of claim 15, wherein the input device is a touchscreen and the vehicle steering system is a steer-by-wire steering system.

17. The automotive vehicle of claim 15, wherein the rotational position change represents an operator steering wheel position preference.

18. The automotive vehicle of claim 15, wherein adjusting the position of the steering wheel from the first position to the second position comprises rotating the steering wheel based on the rotational position change.

19. The automotive vehicle of claim 15, wherein the controller is further configured to adjust a steering wheel rotation setting to one or more of a non-rotation setting, a partial rotation setting, and a full rotation setting.

20. The automotive vehicle of claim 15, wherein the controller is further configured to receive position data from the position sensor, the position data indicative of the first position of the steering wheel.
